(19) United States
(12) Patent Application Publication
(10) Pub. No.: US 2012/0000604 A1
(43) Pub. Date: Jan. 5, 2012

(54) COMPOSITE INSULATED BUILDING PANEL

(76) Inventors: Michel GOULET, Beloeil (CA); Luc McGuire, Trois-Rivieres ouest (CA)

(21) Appl. No.: 13/176,226

(22) Filed: Jul. 5, 2011

Related U.S. Application Data
(63) Continuation of application No. 11/970,145, filed on Jan. 7, 2008.

(51) Int. Cl. B32B 37/12; B32B 37/02

(52) U.S. Cl. 156/334; 156/60; 156/337

(57) ABSTRACT

A building panel comprising a fiberboard panel providing the structural integrity of the building panel. An insulation layer is laminated to the fiberboard panel, the insulation layer providing a required thermal value to the building panel. A functional layer forms an air barrier, a water barrier and/or a vapor barrier of the building panel. The functional layer is secured to the fiberboard panel on the opposite side of the insulation layer.

### CROSS-REFERENCE TO RELATED APPLICATIONS

This patent application is a continuation of U.S. patent application Ser. No. 11/970,145 filed on Jan. 7, 2008 and claims priority on U.S. Provisional Applications No. 60/883,671, filed on Jan. 5, 2007, and No. 60/950,126, filed on Jul. 17, 2007.

### FIELD OF THE APPLICATION

The present application relates to fiberboard panels and, more particularly, to a fiberboard panel used as building panel such as roofing or wall panel and methods of manufacturing and assembling same.

### BACKGROUND ART

In the construction industry, multilayer panels are frequently use as such panels offer multiple functions as a function of the layers than compose them. Such multilayer panels can benefit from their various layers (e.g., elastomeric, asphalt, fiberboard, EPS or XPS, fiberglass, mineral wool etc.) to offer features such as structural support, waterproofness, insulation and fire-resistance.

United States Publication No. 2003/0102184, by Mario Brisson et al., describes an acoustical support panel formed essentially of a support fiberboard layer having a membrane of resilient material thereon. Accordingly, the fiberboard layer provides the structural integrity to the support panel while the membrane of resilient material offers resilience against impact as well as noise insulation. This acoustical support panel is primarily used in flooring applications, for instance to support hardwood flooring panels.

### SUMMARY OF INVENTION

It is an aim of the present invention to provide a novel panel providing additional features.

The panel is a composite product that is made in factory so as to have continuous quality.

Therefore, in accordance with the present application, there is provided a process for fabricating a building panel comprising: receiving a fiberboard panel providing the structural integrity of the building panel; directly laminating an insulation layer with an adhesive to the fiberboard panel off a construction site, the insulation layer providing a required thermal value to the building panel; and directly laminating a functional layer with an adhesive to the fiberboard panel on the opposite side of the insulation layer of the construction site and made of any one of a woven alkene bound by a polymer, a spun polyolefin, a spun polyolefin bound by a polymer, and sheeted polyethylene, to form an air barrier; whereby the building panel is assembled off the construction site for use as an integral building panel on the construction site

Further in accordance with the present application, there is provided a process for fabricating a building panel comprising: receiving a fiberboard panel providing the structural integrity of the building panel; directly laminating an insulation layer with an adhesive to The fiberboard panel off a construction site, the insulation layer providing a required thermal value to the building panel; and directly laminating a functional layer with an adhesive to the fiberboard panel on the opposite side of the insulation layer off the construction site and made of an elastomeric material to form a water barrier for the building panel, the building panel being used in an outdoor application with the functional layer being oriented toward the exterior whereby the building panel is assembled off the construction site for use as an integral building panel on the construction site.

### BRIEF DESCRIPTION OF THE DRAWINGS

FIG. 1 is a sectional view of an insulated building panel constructed in accordance with an embodiment of the present invention;

FIG. 2A is a schematic view of the insulated building panel of FIG. 1, with an overlapping portion of a functional layer;

FIG. 2B is a schematic view of the insulated building panel of FIG. 1, with an offset fiberboard layer; and

FIG. 2C is a schematic view of the insulated building panel of FIG. 1, with an insulation layer being sloped to facilitate drainage.

### DESCRIPTION OF THE PREFERRED EMBODIMENTS

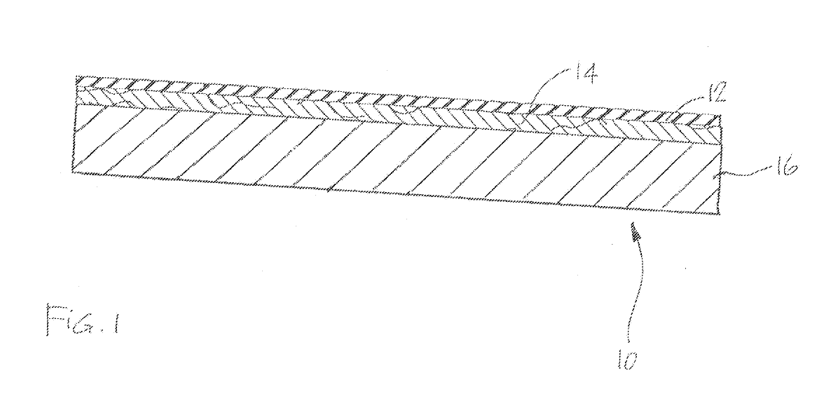

Referring now to the drawings, and more particularly to FIG. 1, a composite insulated building panel constructed in accordance with an embodiment is generally shown at 10, and is also referred to as multilayer building panel.

In the embodiment of FIG. 1, the insulated building panel 10 has three layers, namely a functional layer 12, a fiberboard layer 14, and an insulation layer 16.

The functional layer 12 serves, as the exposed layer.

In one embodiment, the building panel 10 is used as a wall panel, ceiling panel or roofing panel, used either for exterior sides of walls or roofs, or interior sides of walls or ceilings. In outdoor applications, the functional layer 12 forms an air/water barrier that is oriented toward The exterior of the building with respect to the layers 14 and 16. The use of the functional layer 12 as air barrier gives the panel 10 the characteristic of resisting to the passage of water (e.g., rain) while being relatively permeable to vapor. The air-barrier functional layer 12 generally prevents outdoor air from infiltrating in the building or indoor air from exfiltrating through the envelope made of building panels 10. Contemplated materials amongst others for the air-barrier functional layer 12 include woven alkenes bound by polypropylene or other polymers, spun polyolefin optionally bound by polymers, sheeted polyethylene. The air barrier is optional if the building panel 10 is used for indoor applications.

In indoor applications, the functional layer 12 forms a vapor barrier that is oriented toward the interior of the building with respect to the layers 14 and 16. The use of the functional layer 12 as vapor barrier gives the panel 10 the characteristic of being impermeable to the passage of vapor. Accordingly, the functional layer 12 prevents vapor from reaching the insulation layer 16 from the interior of the building. Contemplated materials amongst others for the vapor-barrier functional layer 12 include woven polyethylene, woven polypropylene or mixtures thereof, kraft paper wish polyethylene, some types of paint or polymers, adhesives and sealants, concrete. The vapor barrier is optional if the building panel 10 is used for indoor applications.

In another embodiment, the building panel 10 is used as a roofing panel, whereby the functional layer 12 is made of an elastomeric material which forms the waterproof layer of the building panel 10, preventing water infiltration through the building panel 10 used as part of the roof.

The fiberboard layer 14 provides structural integrity to the building panel 10, also increasing the overall thermal value of the panel. More specifically, the fiberboard layer 14 is made of a fibrous material, such as wood fibers. In an embodiment, the wood fibers are bound into a compression-resistant panel with a bonding agent. Moreover, an additive is optionally used so add a flame and/or smoke retardant property to the fiberboard layer 14. In another embodiment, all six faces of the fiberboard layer 14 are coated with asphalt. As an alternative to wood fibers, it is considered so have layer 14 made of a perlite panel.

The thickness of the fiberboard layer 14 is selected as a function of the contemplated use of the building panel 10 (e.g., flat roof, pitch roof, wall, ceiling, etc.). For instance, a suitable thickness for the fiberboard layer 14 ranges between 0.25″ to 2.0″.

The insulation layer 16 provides the highest thermal value of the three layers of the panel 10 and is therefore primarily added for its insulation properties. The insulation layer 16 is preferably selected from expanded polymers. In an embodiment, the insulation layer 16 is expanded polystyrene, molded or cut. Other polymeric materials considered for the insulation layer 16 include non-exclusively expanded and extruded polystyrene, polyisocyanurate (modified polyurethane), as well as expanded resins such as expanded polypropylene, expanded polyethylene, Arcel™, and the like, and mineral fibers and glass fibers. It is considered to use fire-retardant or flame-retardant additives in the insulation layer 16.

The thickness and density of the insulation layer are selected as a function of the desired insulating value required from the building panel 10. For instance, a suitable thickness for the insulation layer 16 ranges between 0.25″ to 4.0″.

The multi-layer building panel 10 is assembled in plant/factory. The various layers forming the building panel 10 are bound using suitable adhesives in a laminated fashion. As an example, a polyvinyl adhesive (PVA glue), water-based, asphalt-based or pressure-sensitive adhesives, or hot-melt adhesives may all suitably be used to bond the layers 12 (optional), 14 and 16 to one another.

Accordingly, the use of the building panel in simplifies the construction of walls, ceiling and roofs (e.g., flat roof, pitch roof), in that a composite panel provides simultaneously the features of waterproofness and insulation with stable features since it is assembled in factory in reproducible conditions.

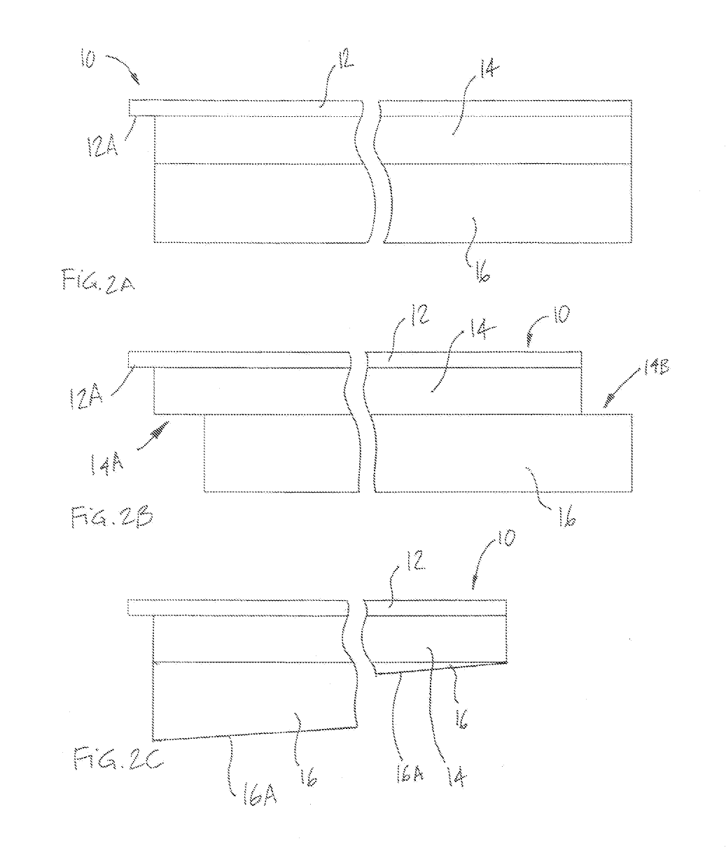

In order to facilitate the on-site assembly of building panels 10 in side-by-side arrangement to form a roof, a wall or a ceiling, various configurations of the panel 10 are considered. In addition to the flat edges of the panel 10 as illustrated in FIG. 1, a few other configurations are illustrated in FIGS. 2A to 2C.

Referring to FIG. 2A, the functional layer 12 is shown having an overlapping portion 12A. In such a case, when panels 10 of FIG. 2A are in a side-by-side arrangement, the overlapping portion 12A overlaps onto the layer 12 of the adjacent panel 10, thereby forming a joint.

When an elastomeric or polymeric material is used for the functional layer 12, it may be required to heat the overlapping portion 12A to ensure that a waterproof joint is formed between adjacent panels 10. Alternatively, the overlapping portion 12A can also be self-adhesive. Although the illustration of FIG. 2A shows one overlapping portion 12A, it is considered to provide panels 10 with a pair of overlapping portions 12A on adjacent edges of the panel 10.

Referring to FIG. 2B, the panel 10 is shown with an offset (e.g., 7/16″) between the fiberboard panel 14 and the insulation layer 16. This creates a pair of complementary joint, portions 14A and 14B that will mate when panels 10 of FIG. 2B are positioned side by side (in a flange-and-shoulder connection). It is considered to form a pair of joint portions 14A and 14B on each panel 10 by offsetting the layer 16 appropriately.

Referring to FIG. 2C, the panel 10 is shown with the insulation layer 16 having a tapering thickness, as shown by surface 16A. Therefore, when a plurality of the panels 10 are positioned side by side, the panel 10 of FIG. 2C will be sloped with respect to the panels of FIGS. 1, 2A and 2B. This configuration is particularly useful when the panel 10 is used for roofs, as it is well suited to facilitate the drainage of a roof by creating a slope, by using The panels 10 of FIG. 2C on the roof made of the composite building panel 10 described herein.

It is considered to provide a strip of protective material to cover the complementary joint portion 14B in the case of the panels 10 of FIG. 2B. The strip of protective material will define a layer of additional material on the layer 14, thereby reducing the risk of exposure to excessive heat when the overlapping portion 121 is fused to join adjacent panels 10.

In roof applications for the building panel 10, once the panels 10 form a roof surface by being positioned side by side, a finishing elastomeric membrane is welded on top of membrane 12 this application is made on job site. All necessary fasteners or adhesives are used to secure the panels 10 to the structure of the building.

When the building panel 10 is used as a wall or ceiling panel, one well-suited dimension is 4′ width by 9′ height, according no standards in the construction industry. Other dimensions are also considered.

It is observed that the building panel 10 as described above has sound attenuating qualities. Accordingly, the panel 10 may be used as a wall panel and/or ceiling panel for sound insulation through walls and floors/ceilings.

1. A process for fabricating a building panel comprising:
receiving a fiberboard panel providing the structural integrity of the building panel;
directly laminating an insulation layer with an adhesive to the fiberboard panel off a construction site, the insulation layer providing a required thermal value to the building panel; and
directly laminating a functional layer with an adhesive to the fiberboard panel on the opposite side of the insulation layer off the construction site and made of any one of a woven alkene bound by a polymer, a spun polyolefin, a spun polyolefin bound by a polymer, and sheeted polyethylene, to form an air barrier;
whereby the building panel is assembled off the construction site for use as an integral building panel on the construction site.

2. The process for fabricating a building panel according to claim 1, wherein receiving the fiberboard panel comprises receiving the fiberboard panel made of wood fibers and a bonding agent.

3. The process for fabricating a building panel according to claim 2, comprising pressing the fiberboard panel into a compression-resistant panel.

4. The process for fabricating a building panel according to claim 1, comprising coating all faces of the fiberboard panel with an asphalt coating.

5. The process for fabricating a building panel according to claim 1, comprising providing at least one of the fiberboard panel and the insulation layer with at least one of flame-retardant additive, a fire-retardant additive and a smoke-retardant additive.

6. The process for fabricating a building panel according to claim 1, wherein directly laminating the insulation layer comprises directly laminating the insulation layer made of a polymeric material.

7. The process for fabricating a building panel according to claim 6, wherein the polymeric material is any one of expanded polystyrene, extruded polystyrene, and polyisocyanurate.

8. The process for fabricating a building panel according to claim 1, wherein directly laminating the insulation layer comprises directly laminating the insulation layer made of at least one of glass fiber and mineral fiber.

9. The process for fabricating a building panel according to claim 1, comprising laminating at least one of the insulation layer and the functional layer to the fiberboard panel using at least one of a polyvinyl adhesive, a water-based adhesive, an asphalt-based adhesive, a pressure-sensitive adhesive and a hot-melt adhesive.

10. The process for fabricating a building panel according to claim 1, comprising using the building panel in an outdoor application, with the functional layer being oriented toward the exterior.

11. The process for fabricating a building panel according to claim 1, wherein receiving the fiberboard panel comprises receiving the fiberboard panel in a thickness ranging between 0.25″ and 2.0″, and the insulation layer in a thickness ranging between 0.25″ and 4.0″.

12. The process for fabricating a building panel according to claim 1, wherein the functional layer has an overlapping portion that overlaps an edge of the fiberboard panel, whereby a joint is formed by the overlapping portion over adjacent ones of the building panel.

13. The process for fabricating a building panel according to claim 12, further comprising an adhesive on the surface of the overlapping portion facing toward the fiberboard layer.

14. The process for fabricating a building panel according to claim 1, wherein the insulation layer is offset with respect to the fiberboard panel for interconnection between adjacent ones of the building panel in flange-and-shoulder connection.

15. A process for fabricating a building panel comprising:
receiving a fiberboard panel providing the structural integrity of the building panel;
directly laminating an insulation layer with an adhesive to the fiberboard panel off a construction site, the insulation layer providing a required thermal value to the building panel; and
directly laminating a functional layer with an adhesive to the fiberboard panel on the opposite side of the insulation layer off the construction site and made of an elastomeric material to form a water barrier for the building panel, the building panel being used in an outdoor application with the functional layer being oriented toward the exterior
whereby the building panel, is assembled off the construction site for use as an integral building panel on the construction site.

16. The process for fabricating a building panel according to claim 15, wherein receiving the fiberboard panel comprises receiving the fiberboard panel made of wood fibers and a bonding agent.

17. The process for fabricating a building panel according to claim 22, comprising pressing the fiberboard panel into a compression-resistant panel.

18. The process for fabricating a building panel according to claim 15, comprising coating all faces of the fiberboard panel with an asphalt coating.

19. The process for fabricating a building panel according to claim 15, comprising providing at least one of the fiberboard panel and the insulation layer with at least one of flame-retardant additive, a fire-retardant additive and a smoke-retardant additive.

20. The process for fabricating a building panel according to claim 15, wherein directly laminating the insulation layer comprises directly laminating the insulation layer made of a polymeric material.

21. The process for fabricating a building panel according to claim 20, wherein the polymeric material is any one of expanded polystyrene, extruded polystyrene, and polyisocyanurate.

22. The process for fabricating a building panel according to claim 15, wherein directly laminating the insulation layer comprises directly laminating the insulation layer made of at least one of glass fiber and mineral fiber.

23. The process for fabricating a building panel according to claim 15, comprising laminating at least one of the functional layer and of the insulation layer to the fiberboard panel using at least one of a polyvinyl adhesive, a water-based adhesive, an asphalt-based adhesive, a pressure-sensitive adhesive and a hot-melt adhesive.

24. The process for fabricating a building panel according to claim 15, wherein receiving the fiberboard panel comprises receiving the fiberboard panel in a thickness ranging between 0.25″ and 2.0″, and the insulation layer in a thickness ranging between 0.25″ and 4.0″.

25. The process for fabricating a building panel according to claim 15, wherein the insulation layer has a tapering thickness along a direction of the fiberboard panel, whereby the building panel is used as a roofing panel being sloped by the tapering thickness for drainage.

26. The process for fabricating a building panel according to claim 15, wherein the functional layer has an overlapping portion that overlaps an edge of the fiberboard panel, whereby a joint is formed by the overlapping portion over adjacent ones of the building panel.

27. The process for fabricating a building panel according to claim 26, further comprising an adhesive on the surface of the overlapping portion facing toward the fiberboard layer.

28. The process for fabricating a building panel according to claim 15, wherein the insulation layer is offset with respect to the fiberboard panel for interconnection between adjacent ones of the building panel in flange-and-shoulder connection.
